(19) United States
(12) Patent Application Publication
(10) Pub. No.: US 2010/0309197 A1
(43) Pub. Date: Dec. 9, 2010

(54) INTERACTION OF STEREOSCOPIC OBJECTS WITH PHYSICAL OBJECTS IN VIEWING AREA

(75) Inventor: Gunjan Porwal, Pune (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 12/480,673

(22) Filed: Jun. 8, 2009

(51) Int. Cl. G06T 15/00

(52) U.S. Cl. 345/419

(57) ABSTRACT

Changing the path of a virtual object displayed in a stereographic form when a physical object is encountered in the path of the virtual object. Sensors may be used to identify the location of physical objects present in an area of interest (in the viewing area), and the determined location information may be used to determine whether a physical object is present in the path of a virtual object. In an embodiment, a gaming system receives the location information and determines whether a “collision” would occur. In an alternative embodiment, the sensor receives information of the original path of the virtual object, determines the new path based on location information and sends back the new path information to the gaming system.

### BACKGROUND OF THE INVENTION

1. Technical Field

The present disclosure relates to stereoscopic displays and more specifically to enhancing user experience when displaying objects using stereoscopic techniques.

2. Related Art

Stereoscopic technique refers to techniques which provide visual perception in all three dimensions to viewers, i.e., viewers are able to have the depth perception as well clearly. Stereoscopic displays generally work by producing two different images of the same view, at the same time, one for the left eye, and another for the right eye. Each of these two images reach respective eye of the user simultaneously (based on appropriate technology), and the brain combines these two images and gives the viewer the perception of depth, as if the object is coming out of screen.

The objects thus displayed in 3-dimensions are referred to as stereoscopic objects (also referred to as virtual objects hereafter). It may be appreciated that the virtual object (such as a ball rendered on a display unit) provides only a perception of its presence when the object is rendered on a display unit in sharp contrast to physical objects (such as wall, floor, table etc.) which are physically present and can be felt by touching.

There are several environments (e.g., entertainment, gaming, etc.) in which it is desirable to provide enhanced user experience to viewers of stereoscopic displays.

### BRIEF DESCRIPTION OF THE DRAWINGS

Example embodiments of the present invention will be described with reference to the accompanying drawings briefly described below.

FIG. 1A is a block diagram illustrating the details of an example system in which several aspects of the present invention can be implemented.

FIG. 1B is an example environment in which several aspects of the present invention are illustrated.

FIG. 2 is a flow chart illustrating the manner in which the user experience is enhanced when displaying objects using stereoscopic techniques according to an aspect of the present invention.

FIG. 3 is a block diagram illustrating the details of a gaming system in an embodiment of the present invention.

FIG. 4 illustrate the path of a virtual object before and after “collision” with a physical object.

FIG. 5 illustrates the user experience of change of path when a physical object is present in the path of a virtual object, in an embodiment.

FIG. 6 is a block diagram illustrating the details of a digital processing system in which several features of the present invention are operative upon execution of appropriate software instructions in an embodiment of the present invention.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

1. Overview

According to an aspect of the present invention, the path of a virtual object rendered in stereoscopic mode is changed if a physical object is present in the path (as would be perceived by the viewers). Sensors may be used to determine the location of physical objects in the viewing area, and the location information may be used to determine whether a physical object is present in the path of the virtual object.

In an embodiment, a gaming system receives the location information and determines whether a “collision” would occur (i.e., if a physical object is present in the path). In an alternative embodiment, sensors receive information of the original path of the virtual object, determines the new path based on location information and sends back the new path information to the gaming system. The virtual object is rendered to travel in the new path after a time instance at which “collision” would occur with the physical object.

Several aspects of the invention are described below with reference to examples for illustration. However one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore the features/aspects described can be practiced in various combinations, though only some of the combinations are described herein for conciseness.

2. Example System

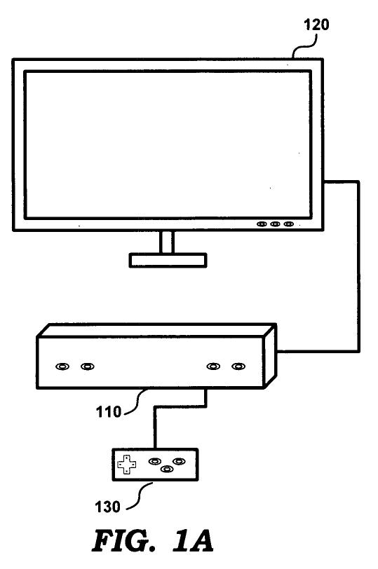

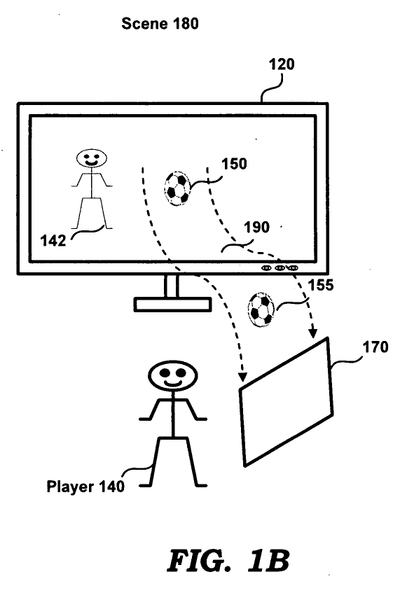

FIG. 1A is a block diagram illustrating an example system (gaming system) in which several aspects of the present invention can be implemented. While the features are described below with respect to gaming system merely for illustration, it should be understood that the features can be implemented in other types of systems that uses stereoscopic techniques to display objects, in particular, without the user interaction common in gaming systems.

The block diagram is shown containing game console 110, (stereoscopic) display unit 120, and game controller 130. Merely for illustration, only representative number/type of systems/components are shown in the Figure. Many environments often contain many more or fewer systems, both in number and type, depending on the purpose for which the environment is designed.

Game console 110 represents a system providing the necessary hardware (in addition to any required software) environment for executing gaming applications. While the hardware provides the necessary connection/association between game console 110 and other systems and input/output devices such as display unit 120, game controller 130 etc., the software environment provides the necessary interface between the game console and other devices. The software includes operating system, drivers for interfacing with input/output devices.

In addition, game console 110 may contain a non-volatile storage such as a hard disk and may also contain the necessary drives/slots wherein a user can load corresponding media storing the gaming application. Further, game console 110 receives inputs from game controller 130 and sends images for rendering to display unit 120, Additionally, audio for reproduction to audio output devices (not shown) via corresponding hardware and interfaces may be provided by game console 110.

The game controller 130 represents an input device primarily for providing inputs according to specific implementation of the game/gaming application. For example, specific controls in game controllers are to be pressed for performing specific functions (e.g., to shoot/throw a ball when playing games like soccer, volley ball etc, to accelerate a car, etc.) in a corresponding game. In one embodiment, the game controller is designed to provide force feedback (e.g. vibrate) based on the data received from game console 110. Example game controllers include devices such as mouse, keyboard, generic game pad, etc., or a special controllers used with specific gaming applications such as wheel, surfboard, guitar etc. Game controller is associated with game console either in a wired or wireless manner.

Stereoscopic display unit 120 provides for stereoscopic display of at least some displayed elements/virtual objects. The unit is shown associated with game console 110 indicating that game console 110 provides the data to be rendered on display unit 120 and accordingly display unit 120 renders the images. Any necessary accessories (e.g., special goggles/viewing glasses) may be used by users (or viewers) to experience the depth perception of the rendered images. Rendered images may contain virtual objects (such as ball) corresponding to the implementation of game/gaming application. In particular, the some of the elements/virtual objects rendered on the display unit appear to emerge from the screen in a specific direction.

In general, stereoscopic display unit 120 displays virtual objects providing a depth perception of the virtual object to the viewers as noted above in the background section. In such a display, the virtual objects may be rendered such that the viewers/players get a perception that the virtual objects are coming/emerging out of the screen (towards the players/viewers). In such a scenario, it may be necessary to enhance user experience when displaying virtual objects using stereoscopic techniques. Several aspects of the present invention enhance user experience when displaying virtual objects using stereoscopic techniques as described below with examples.

2. Example Environment

FIG. 1B represents an example environment in which several features of the present invention can be implemented. The environment is shown containing some of the components of FIG. 1A along with a viewer/user/player 140, role 142 and physical object 170. For conciseness, only representative elements/objects (both virtual and physical), for illustration of an example context have been included in the example scene. However, additional elements/objects may be contained in a scene for a corresponding gaming application.

Ball (at location 150) representing a virtual/stereoscopic object is shown emerging out (as would be perceived by viewers, due to the corresponding stereoscopic display) of screen of display unit 120. The scene there corresponds to a gaming application such as soccer, volley ball etc., played using a ball. It is assumed that the gaming application that is part of the gaming console 110 controls the path of ball virtual object based on the player (140) input, who may be providing the inputs using the controller 130. Broadly, player 140 may cause role 142 to perform actions such as playing a ball-game, which causes ball virtual object to traverse virtual path 190.

A scene represents a snapshot of current status of the objects involved in the game at a specific time instance. In the example scene 180, the specific time instance corresponds to the occurrence of event representing “player 140 controlling the virtual object (ball) to reach display portion 155 from display portion 150 in the path 190 (shown between the dotted curving lines)” and it is assumed that the ball is (rendered to be) emerging towards player 140 for corresponding user experience.

Thus, player 140 will have the perception of a “Ball” emerging out of the display unit towards him/her as indicated by display portion/location 155. In an embodiment, path 190 of the emerging object (ball) is calculated/computed by the gaming application (which is part of the gaming console) based on the user/player (140) input given using the controller 130.

Physical object 170 is shown present within an area of interest (specific area/region or viewing area, in general) where the player 140 is playing the game and the gaming system is present. While physical object 170 may represent an object such as a wall or a table, alternative embodiments can employ any suitable object for a desired game/environment, such as a racket, bat, sword, gun, etc.

Several aspects of the present invention provide for enhanced user experience in a scenario when an emerging virtual object (ball) in its original path (190) encounters or reaches or collides (providing such a perception) a physical surface/object 170 (as shown in FIG. 1B), as described below with examples.

3. Enhancing User Experience

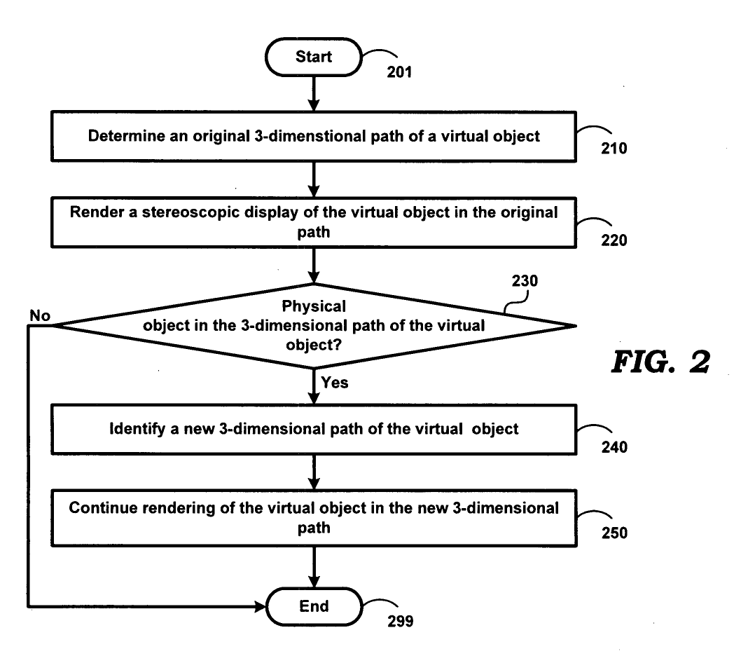

FIG. 2 is a flow chart illustrating the manner in which user experience when displaying objects using stereoscopic techniques can be enhanced according to an aspect of the present invention. The flowchart is described with respect to FIGS. 1A and 1B merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, game console 110 (or the gaming application) determines an original 3-dimensional (virtual) path of a virtual object. The determination of the original 3-dimensional path may be performed dynamically based on the interaction (e.g. in response to a user input) associated with the virtual object. For example, the original 3-dimensional path 190 of stereoscopic display of virtual object ball in scene 180 may be determined in response to the action of the player 140 shooting the ball in a specific direction/location (or providing corresponding controls using game controller 130). It should be appreciated that the original 3-dimensional path (190) can be determined using various approaches, taking into account the specific context in which the virtual object is rendered.

In step 220, game console 110 (or the gaming application) renders a stereoscopic display of the virtual object in the determined original path (for a first time duration), according to a gaming logic being implemented. Rendering implies generating display signals to cause one or more images (that includes virtual objects) representing a scene to be displayed. For the desired stereoscopic effect, at least the corresponding image portion may be rendered as two images (for the same scene) for respective one of the pair of eyes of a viewer. It should be further appreciated that the elements/virtual objects of the scene and the content of the scene otherwise, may further be defined by the various user interactions and the program logic implementing the underlying game.

In step 230, game console 110 (or the gaming application) determines if there is a physical object in the determined 3-dimensional path of the virtual object. Physical objects are the objects in the viewing area that are different from the virtual objects rendered by the gaming application. Control passes to step 240 if a physical object is determined to be in the original 3-dimensional path and to step 299 otherwise.

In step 240, game console 110 (or the gaming application) identifies a new 3-dimensional (virtual) path of the virtual object. The new 3-dimensional path may be identified by performing computations based on various factors such as, the location of the physical object and the distance (with respect to the center of the display unit 120) at which the virtual object encountered/touched/collided the physical object, angle at which the virtual object touched the physical object, the nature of the surface at the virtual point of impact, etc.

In one embodiment, game console 110 uses physics laws to compute the new 3-dimensional path. Such a calculation may further include using equations defined as per the physics laws specifically the laws describing the position of an object with respect to its interaction with its surroundings.

In step 250, game console 110 (or the gaming application) continues rendering of the virtual object in the new 3-dimensional path. As noted above, rendering entails forming an image data and such data is rendered in the identified new 3-dimensional path. The flow chart ends in step 299. It may be noted that the virtual object is rendered in the new path for another time duration (second time duration) that is later than the first time duration used for rendering the virtual object in original path. Furthermore, the change of path is effected at a time instance when the virtual object would touch (or collide with) the physical object.

It may thus be appreciated that the 3-dimensional path (original) of a virtual object is re-computed when a physical object is found in the original 3-dimensional path and the virtual object is continued to be rendered in the re-computed path (new path) thereby enhancing the user experience. Such features can be taken advantage of by various games according to corresponding designs.

While the features of the flowchart are described with respect to FIG. 1B merely for illustration, it should be appreciated that complex games will be able to use the features of the present invention, as suited for the corresponding gaming logic. Furthermore, the features described above may be implemented using various architectures/approaches, as described below with respect to an example implementation.

4. Example Implementation

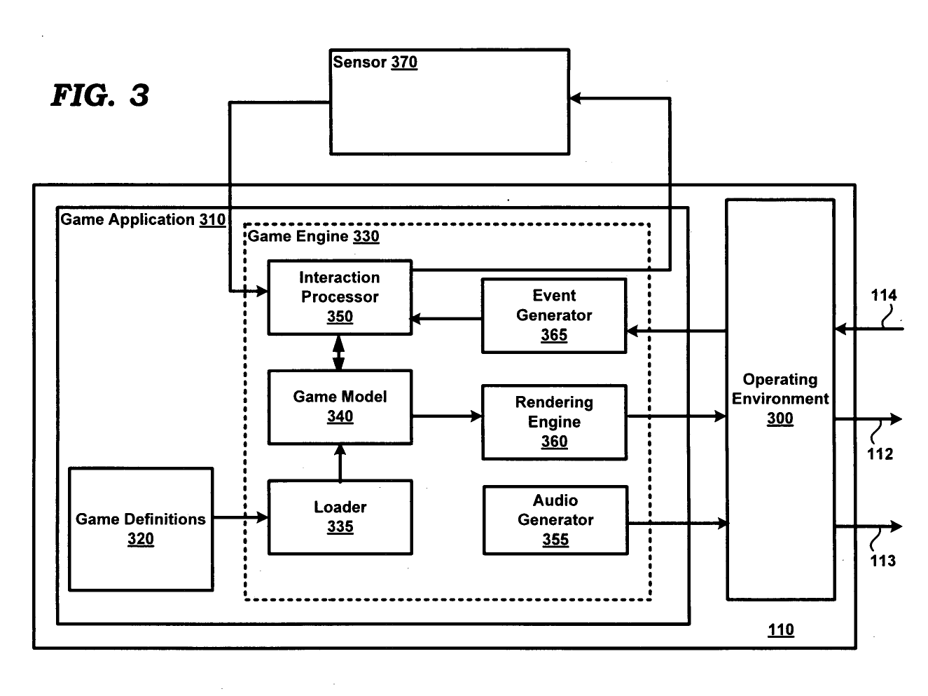

FIG. 3 is a block diagram illustrating the implementation of game console 110 in one embodiment. Game console 110 is shown containing operating environment 300, and game application 310 (containing game definitions 320 and game engine 330). Game engine 330, in turn is shown containing loader 335, game model 340, interaction processor 350, audio generator 355, rendering engine 360, event generator 365. Also shown is a sensor 370 (external to the game console 110).

For illustration, only representative blocks (in type and number) are shown, though alternative embodiments in accordance with several aspects of the present invention can contain other blocks. Each block may be implemented as an appropriate combination of one or more of hardware (including integrated circuit, ASIC, etc.), software and firmware. Each of the blocks in described in detail below.

Sensor 370 is used to detect the presence of various physical surfaces in the viewing area (area of interest in the illustrative example). While only a single sensor is shown, it should be appreciated that multiple sensors may be employed to detect the physical objects (and the corresponding surfaces/properties, which may determine the direction of new path and other characteristics of the object upon “collision”). Such sensors may be distributed over the viewing area for appropriate coverage, as desired.

Operating environment 300 represents necessary software/hardware modules providing a common environment for execution of game applications. Operating environment 300 may include operating systems, virtual machines, device drivers for communicating (via paths 112-114) with input/output devices associated with game console 110, etc. Operating environment 300 may further load portions of the executable file representing the game application 310 and data associated with the game application into memory within game console 110. Operating environment 300 may also manage storage/retrieval of game state for save/load game functionality.

Game application 310 represents one or more software/executable modules containing software instructions and data which on execution provide the various features of the game. Game application 310 is shown containing game definitions 320, which represents the art work (such as images, audio, scripts, etc) and the specific logic of the game and game engine 330 which contains the software/programming instructions facilitating execution of the game (according to the game definitions 320).

Game definitions 320 represent software/data modules implementing the game applications and corresponding logics, as well as object data for various virtual objects provided according to several aspects of the present invention. The game definitions may also contain object data to represent scenes, (part of) content of each scene, the image/audio data corresponding to elements/virtual objects of the game, the manner in which elements/virtual objects interact with each other (typically implemented using scripts), etc.

The virtual object (ball) data can indicate that the object definition corresponds to a 3-dimensional object (for example, the ball in location 150 shown in scene 180) and thus should include variables/attributes such as points, edges corresponding to a 3D display, location of instance of the element/virtual object with reference to a scene, color, texture. As is well known, each 3D virtual object/element can be rendered using co-ordinates of a set of points and/or the vectors representing edges.

The virtual data can further contain information which controls the path (original as well as new) and other attributes (e.g., shape, texture, size, etc.) of the virtual objects (including ball) before and after collision with the physical objects. For example, the data may indicate that the new path needs to be computed based on the nature of surface with which the virtual object collides, or alternatively may indicate a fixed new path (as a static value) in case of collision.

In an embodiment data structure representing a virtual object (for example ball at location 150) in a game can be implemented using C++ like language. It should be appreciated that such data structures are generally provided in the form of a library, with the developer of the game then creating desired instances of the objects by populating the attributes/variables of the data structure.

Game engine 330 facilitates execution of the game according to the data contained in game definitions 320. Game engine 330 may facilitate functions such as Internet access, interfacing with file systems via operating environment 300 (to load/save the status of games while playing the game), etc. Game engine 330 may also interface with operating environment 300 to receive inputs (via path 114) by execution of corresponding instructions. In addition, game engine 330 generates video data and audio stream based on the specific object data in game definitions 320 for a corresponding scene. Each block of game engine 330 performing one or more of the above functions is described in detail below.

Loader 335 retrieves and loads either all or portions of game definitions 320 into game models 340 depending on specific parameters such as “complexity level” selected by the player (140), current level (of game) the player is in, etc. For the example scene 180, loader 335 may generate (or instantiate) instances of roles/levels corresponding to player 140 and instances of the ball (virtual) object for rendering of the corresponding virtual objects/elements as part of scene 180.

Game model 340 stores/maintains state information (in RAM within game console 110) which may include data structures indicating the state (current and any previous state) of virtual objects/elements in the game. For example, the data structures for a present state may include data representing the present scene (such as scene 180), virtual objects/elements (such as player 140, and ball) in the scene and details of each virtual objects/element (e.g., location/path/direction of each virtual object/element in the scene, the history of interactions that have occurred on each element/virtual object), etc.

Audio Generator 355 sends audio stream in path 113 using drivers/systems provided by operating environment 300 within game console 110 based on the present status of various objects and other considerations (e.g., programmer may have specified background music). Some of the sound streams (e.g., upon collision) may be specific to virtual objects. The audio stream for an element/virtual object is provided in time-correlation with rendering of the corresponding element/virtual object.

Rendering engine 360 may receive/poll data contained in game models 340 in order to determine changes in the present state of the virtual objects/elements. Based on determination of a change in the present state (for example, in response to a user input), rendering engine 380 may form image frames, and then render elements/virtual objects of a scene (180) on display unit 120 based on the formed frames.

Event generator 365 generates events/notifications (sent to interaction processor 350) in response to receiving inputs (via path 114) and/or based on time. The notifications may be generated based on the identifier(s) of the player(s), specific controls (if any) pressed by the player(s). The notifications may also be generated based on any control information such as system time, elapsed time for the game etc.

Interaction processor 350 operates in conjunction with event generator 340 and sensor 370 to determine the specific effect on the elements/virtual objects in the current state/scene of the game (maintained in game models 340) using techniques such as collision detection, impact analysis, etc. Interaction processor 350 then updates the data in game models 340 such that the object data in game models reflects the new state of the virtual objects/elements in the scene, in view of the impact/collision with the physical object.

As noted above, an aspect of the present invention determines a new path for a virtual object when a physical object is encountered in the present path. The manner in which such presence may be determined and the new path may be computed is described below with respect to examples.

5. Determining Presence of Physical Object

In an embodiment, interaction processor 350 determines the path in which a virtual object/element (such as ball virtual object) is to be stereoscopically rendered at various time instances of a game (being played) on a display screen (120) and is described in detail below. The paths may be computed dynamically and/or specified statically, generally in a known way, based on various definitions provided within the object data.

In one implementation, sensor 370 detects various physical objects present in the viewing area (general area of interest). The information may include the position of a physical object with respect to the center of the display screen, size of the physical object, nature of the physical surface, etc., as required depending on the environment in which it is operating. Further sensor 370 may detect the physical objects before storing the information (about the physical objects) and may perform continuous detection for new/removed physical objects in the area of interest.

It may be noted one or more sensors may be used to collect the required information (though only a single sensor is shown). For example 3 sensors can be used to collect and provide information related to location of the physical object in 3-dimensional coordinate space (such as x,y and z).

Furthermore sensor 370 sends the location information (after detecting and storing) of the physical objects to the interaction processor 350 in one embodiment. Interaction processor 350 receives the information and then checks whether the location is within the virtual path of a virtual object. It may be appreciated that a collision would be perceived when the virtual object travels to the location. Accordingly, the time instance at which such collision would occur (or be perceived) may be determined depending on the virtual path being traversed, speed, etc. A new path (to be taken after collision) may also be computed when a collision is detected (by interaction processor 350) with a specific physical surface.

In another embodiment, interaction processor 350 sends the information about the determined original path (along with time information indicating where in the path at each time instance the virtual object is expected to be perceived) to sensor 370, and sensor 370 re-computes the path (new path) after detecting that the virtual object would collide with a specific physical surface/object and sends the re-computed data values to the interaction processor 350. Interaction processor 350 receives the data values and updates the game models (340) to reflect the new path and also the time instance (corresponding to collision) from which the new path would be effective.

The determined original path and the identified new path (based on the presence of a specific physical object) associated with the ball virtual object may be specified in any desired manner. One such manner in which the original path and new path is specified as a 3 dimensional vector in an embodiment is described below.

6. Example Operation

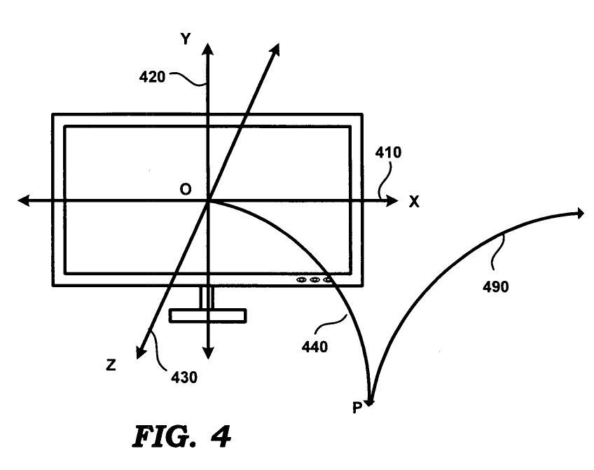

FIG. 4 depicts the path of a virtual object at various time instances before and after “collision” with a physical object in an example scenario.

The original path (440) may be defined in terms of co-ordinates with respect to three axes X, Y and Z (lines 410, 420 and 430), with the origin O at the intersection of the three axes. Interaction processor 350 determines an original path (440) (corresponding to path 190 in FIG. 1B) as a function of time (i.e., indicating the specific position at which the virtual object would be perceived to be at each of a successive time instances). It may be appreciated that the stereoscopic display rendered on display unit 120 may enable/allow that the original path (at least a part of) determined be outside of the display unit 120. Thus, the virtual object (ball while at location 155) is rendered in such a way that the ball has emerged out of the screen towards the players/viewers (140).

Interaction processor 350 further detects that the ball virtual object has collided with a physical surface at point P (based on, for example, on determining that the virtual object along path 440 would be at point P, where a surface of a physical object is/would also be present at the same time instance). Interaction processor 350 accordingly identifies a new 3-dimensional path (by computing) 490. Interaction processor may use information such as angle at which the ball virtual object would touch physical object 170, the impact of the touch, attributes of the ball and co-ordinates of the location of the ball with respect to the center of the display screen, the information received from sensor 370 about the physical surface, etc., to identify the new path (represented as a 3-dimensional path).

Interaction processor 350 then updates the data for the identified path (490) contained in the object data of the element/virtual object (maintained as part of game models 340). The data values of the original path as well as the new path may then be retrieved and used by rendering engine 380 to render the stereoscopic display in the identified path at specific time instances and is described below in detail.

It may be observed that the origin O is shown as being in the center of stereoscopic display unit 120. However, in other embodiments, the location of origin O can be located at other points such as the bottom-right corner of display unit 120, another element/object in the scene, etc.

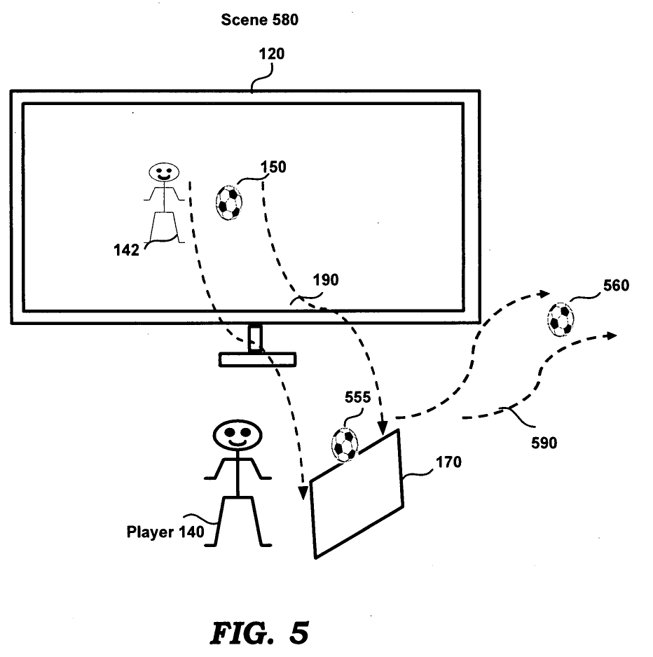

FIG. 5 illustrates the user experience of change of path when a physical object is present in the path of a virtual object, in an embodiment. Broadly, the same ball (virtual object) shown at 150/555/560 (at corresponding time instances) along original path 190 is shown to be colliding with physical object 170 (at 555), and is shown taking a new path 590.

Thus, player 140 will have the perception of a “Ball” bouncing of the physical object 170 after providing a perception that the ball touched the corresponding physical object (170) as indicated by display portion/location 555.

It may be noted that the first duration (during which the ball virtual object was rendered in the original path 190) is before the first time instance (the time instance at which the collision with the physical object was detected) and the second duration (during which the ball virtual object was rendered in the new path 590) is later than the first time instance.

Thus, the objects are rendered, in a path that correlates with the stereoscopic display of the object in the scene. In particular, when the objects in a scene appear to emerge in a specific path (original path) and a physical object is present in the original path, the rendering path is re-calculated to another path (new path) and the objects are continued to be rendered in the new path enhancing user experience.

While the description above is provided with respect to an environment, where, users/teams may be associated with a game console in a location, the features can be implemented in gaming environments where several users may access a game console from multiple different locations over a network. In such a scenario, interactions may be received into game console over the network and corresponding response indicating the path/direction and audio may be sent to the users via the same network in order to provide the path which is correlated with the interactions of the virtual object with the physical objects in the area of interest.

It should be appreciated that the above-described features may be implemented in a combination of one or more of hardware, software, and firmware (though embodiments are described as being implemented in the form of software instructions). The description is continued with respect to an embodiment in which various features are operative by execution of corresponding software instructions.

5. Digital Processing System

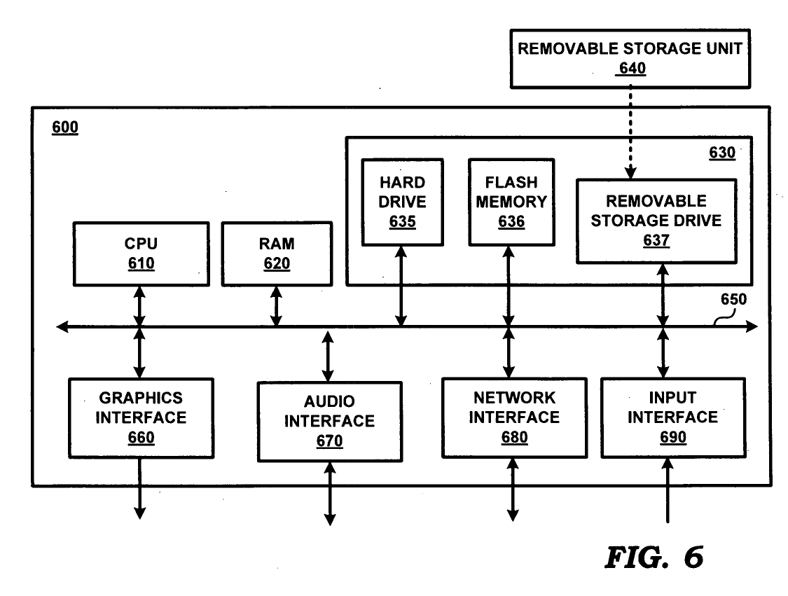

FIG. 6 is a block diagram illustrating the details of digital processing system 600 in which various aspects of the present invention are operative by execution of appropriate software instructions. Digital processing system 600 may correspond to game console 110.

Digital processing system 600 may contain one or more processors such as a central processing unit (CPU) 610, random access memory (RAM) 620, secondary memory 630, graphics interface 660, audio interface 670, network interface 680, and input interface 690. All the components may communicate with each other over communication path 660, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single general-purpose processing unit. RAM 620 may receive instructions from secondary memory 630 using communication path 650.

Graphics controller 660 generates display signals (e.g., format required for stereoscopic display) to display unit 120 based on data/instructions received from CPU 610. The display signals generated may cause display unit 120 to provide stereoscopic display of the scenes (as described above with respect to FIG. 1B and FIG. 5). Audio interface 670 generates audio signals to audio output devices (not shown) based on the data/instructions received from CPU 610.

Network interface 680 provides connectivity to a network (e.g., using Internet Protocol), and may be used to communicate with other connected systems (such as other game consoles associated with players on another location). Input interface 690 may correspond to a keyboard, a pointing device (e.g., touch-pad, mouse), game controllers 140A-140B and may be used to provide inputs (e.g., such as those required for the playing the game, to start/stop of execution of a game application, etc.).

Secondary memory 630 may contain hard drive 635, flash memory 636, and removable storage drive 637. Secondary memory 630 may store the data (e.g., game models 360, game definitions 320, player profiles, etc.) and software instructions, which enable digital processing system 600 to provide several features in accordance with the present invention.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable storage medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the following description, numerous specific details are provided such as examples of programming, software modules, user selections, network transactions, database queries, database structures, hardware modules, hardware circuits, hardware chips, etc., to provide a thorough understanding of embodiments of the invention.

6. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A system comprising:
a processor;
a memory; and
a computer readable storage medium to store one or more instructions, which when retrieved into said memory and executed by said processor causes said system to perform a plurality of actions comprising:
determining an original 3-dimensional path of a virtual object;
rendering a stereoscopic display of said virtual object in said original path; and
if a physical object is present in said 3-dimensional path of said virtual object, identifying a new 3-dimensional path of the virtual object and continuing rendering of said virtual object in said new 3-dimensional path.

2. The system of claim 1, wherein said virtual object is rendered in said original 3-dimensional path in a first duration,
said virtual object in said original 3-dimensional path is found to collide with said physical object at a first time instance and said continuing in said new 3-dimensional path is performed in a second duration,
wherein said first time instance is after said first duration and said second duration is after said first time instance,
wherein said original 3-dimensional path is different from said new 3-dimensional path,
whereby a user perceives the path of said virtual object changing due to the presence of said physical object in said original 3-dimensional path.

3. The system of claim 2, further comprising a display screen, wherein said original 3-dimensional path is rendered to be coming out of said display screen, wherein said physical object is outside of said system.

4. The system of claim 3, further comprising a sensor to detect a location of said physical object, wherein identification of said new 3-dimensional path is performed based on said detected location.

5. The system of claim 4, wherein said sensor sends coordinates of said location to said processor, wherein said processor computes said new 3-dimensional path based on said received coordinates to identify said new 3-dimensional path.

6. The system of claim 4, wherein said sensor is designed to receive said original 3-dimensional path from said processor,
said sensor to compute said new 3-dimensional path based on the coordinates of said detected location and said received original 3-dimensional path, and sends said new 3-dimensional path to said processor,
whereby said identifying comprises receiving said new 3-dimensional path from said sensor.

7. The system of claim 4, wherein said processor and said memory are comprised in a gaming system, and said sensor is provided external to said gaming system,
wherein said virtual object is rendered while said user plays a game on said gaming system.

8. A method of enhancing user experience when displaying virtual objects using stereoscopic techniques, said method being implemented in a system, said method comprising:
determining an original 3-dimensional path of a virtual object;
rendering a stereoscopic display of said virtual object in said original path; and
if a physical object is present in said 3-dimensional path of said virtual object, identifying a new 3-dimensional path of the virtual object and continuing rendering of said virtual object in said new 3-dimensional path.

9. The method of claim 8, wherein said virtual object is rendered in said original 3-dimensional path in a first duration,
said virtual object in said original 3-dimensional path is found to collide with said physical object at a first time instance and said continuing in said new 3-dimensional path is performed in a second duration,
wherein said first time instance is after said first duration and said second duration is after said first time instance,
wherein said original 3-dimensional path is different from said new 3-dimensional path,
whereby a user perceives the path of said virtual object changing due to the presence of said physical object in said original 3-dimensional path.

10. The method of claim 9, wherein said original 3-dimensional path is coming out of a display screen, wherein said physical object is outside of said system and said display screen is part of said system.

11. The method of claim 10, wherein a location of said physical object is detected using a sensor, wherein said identifying is performed based on said location.

12. The method of claim 11, wherein said identifying further comprises receiving coordinates of said location, and computing said new 3-dimensional path based on said receiving.

13. The method of claim 11, further comprises sending data identifying said original 3-dimensional path to said sensor, wherein said sensor computes said new 3-dimensional path and sends back the computed new 3-dimensional to said system.

14. A computer readable medium storing one or more sequences of instructions causing a system to enhance user experience when displaying virtual objects using stereoscopic techniques, wherein execution of said one or more sequences of instructions by one or more processors contained in said system causes said system to perform the actions of:
determining an original 3-dimensional path of said virtual object;
rendering a stereoscopic display of said virtual object in said original 3-dimensional path; and
identifying a new 3-dimensional path of the virtual object and continuing rendering of said virtual object in said new 3-dimensional path if a physical object is present in said 3-dimensional path of said virtual object.

15. The computer readable medium of claim 14, wherein said virtual object is rendered in said original 3-dimensional path in a first duration, wherein said physical object is found to be in said original 3-dimensional path at a first time instance,
wherein said continuing in said new 3-dimensional path is performed in a second duration,
wherein said first time instance is after said first duration and said second duration is after said first time instance,
wherein said original 3-dimensional path is different from said new 3-dimensional path,
whereby a user perceives the path of said virtual object changing due to the presence of said physical object in said original 3-dimensional path.

16. The computer readable medium of claim 15, wherein said original 3-dimensional path is coming out of a display screen, wherein said physical object is outside of said system and said display screen is part of said system.

17. The computer readable medium of claim 16, further comprises detecting a location of said physical object using a sensor, wherein said identifying is performed based on said location.

18. The computer readable medium of claim 17, wherein said identifying further comprises receiving coordinates of said location, and computing said new 3-dimensional path based on said receiving.

19. The computer readable medium of claim 17, further comprises sending data identifying said original 3-dimensional path to said sensor and receiving coordinates of said new 3-dimensional path in response.

20. The computer readable medium of claim 17, wherein said system is a gaming system, and said sensor is provided external to said gaming system,
wherein said virtual object is rendered while said user plays a game on said gaming system.
